(19) United States
(12) Patent Application Publication
(10) Pub. No.: US 2006/0098790 A1
(43) Pub. Date: May 11, 2006

(54) Automatically configuring remote monitoring of a provisionable resource

(76) Inventors: John J. Mendonca, Redwood Shores, CA (US); Richard H. Van Gaasbeck, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/982,039

(22) Filed: Nov. 5, 2004

(51) Int. Cl. H04M 1/24

(52) U.S. Cl. 379/29.1

(57) ABSTRACT

Methods and systems for automatically configuring remote monitoring of provisionable resources are provided. In one embodiment, information describing provisionable resources is received without requiring manual entry of the information. A list of monitored resources is automatically configured with the information so that a network operations center is enabled to remotely monitor the provisionable resources.

### TECHNICAL FIELD

Embodiments of the present invention relate to managing provisionable resources. More specifically, embodiments of the present invention relate to automatically configuring remote monitoring of a provisionable resource.

### BACKGROUND ART

FIG. 1 is a block diagram of a prior art system for monitoring the status of provisionable resources. As depicted in FIG. 1, system 100 includes provisionable resources 140, a utility computing facility 130 and a network operations center 110 (NOC). The utility computing facility 130 includes a database 138 The NOC 110 includes a list of monitored resources 112, a manual configuration interface 114, and a monitoring service 116.

The utility computing facility 130 can be used to manage provisionable resources 140. For example, provisionable resources 140 can be grouped in what is commonly known in the art as “farms.” More specifically, provisionable resources 150, 160, 170 may be grouped into one farm and provisionable resources 180, 190 may be grouped into another farm.

Information describing the “farms” can be stored in the database 138 associated with the utility computing facility 130. The utility computing facility 130 can use “farms,” for example, to allocate and de-allocate provisionable resources 140 to an application that needs resources, such as storage, to execute.

An administrator can use the manual configuration interface 114 to enter information describing the provisionable resources 140 that the monitoring service 116 is supposed to monitor. The manual configuration interface 114 causes the entered information to be stored in the list of monitored resources 112.

Agents 152, 162, 172, 182, 192 can be manually installed on the provisionable resources 140 for the purpose of reporting resource metrics, such as the status of whether the provisionable resources 140 are “up” or “down,” to the monitoring service 116. The monitoring service 116 compares the information stored in the list of monitored resources 112 with the status received from the agents 152, 162, 172, 182, 192 installed on the provisionable resources 140.

For these and other reasons, a method and/or a system that automatically configures a network operations center for the purpose of monitoring provisionable resources would be valuable. A method and/or system that enables a network operations center to directly monitor provisionable resources would also be valuable.

### DISCLOSURE OF THE INVENTION

Embodiments of the present invention pertaining to methods and systems for automatically configuring remote monitoring of provisionable resources are described. In one embodiment, information describing provisionable resources is received without requiring manual entry of the information. A list of monitored resources is automatically configured with the information so that a network operations center is enabled to remotely monitor the provisionable resources.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a prior art system for monitoring the status of provisionable resources.

FIG. 2 is a block diagram of a system for automatically configuring remote monitoring of provisionable resources, according to embodiments of the present invention.

FIG. 3 depicts a flowchart for automatically configuring remote monitoring of provisionable resources, according to embodiments of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

### SOFTWARE SYSTEM AND FUNCTIONAL OVERVIEWS

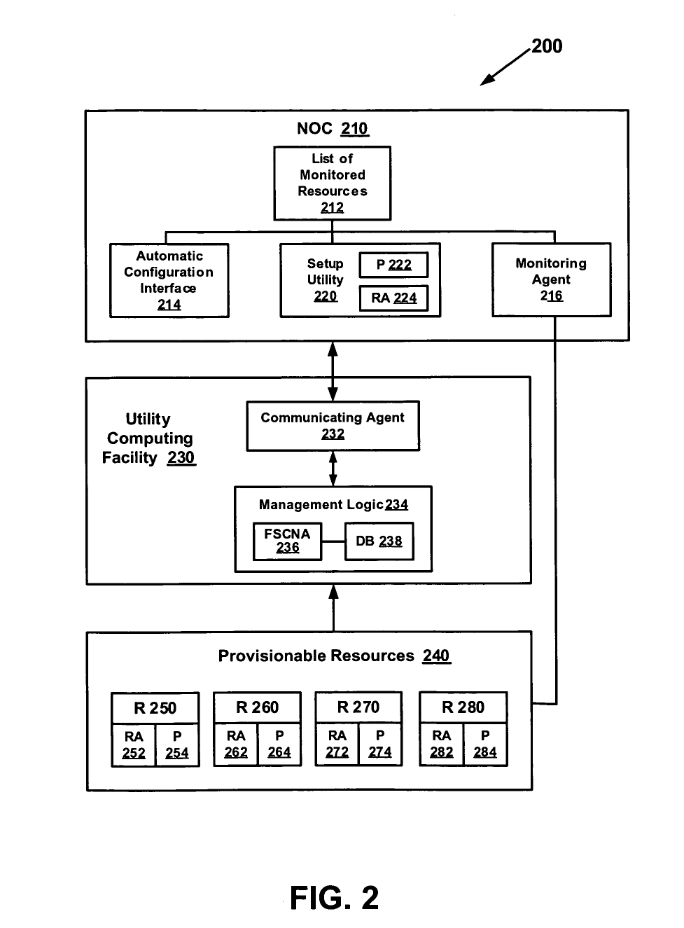

FIG. 2 is a block diagram of a system for automatically configuring remote monitoring of provisionable resources, according to one embodiment of the present invention. The blocks in FIG. 2 can be arranged differently than as illustrated, and can implement additional or fewer features than what are described herein. Further, the features represented by the blocks in FIG. 2 can be combined in various ways.

As depicted in FIG. 2, system 200 includes a NOC 210, a utility computing facility 230, and provisionable resources 240 (e.g., 250, 260, 270, 280). The NOC 210 includes a list of monitored resources 212, an automatic configuration interface 214, a setup utility 220, and a monitoring agent 216. The setup utility 220, according to one embodiment, can include uninstalled policies 222 and/or reporting agents 224. The utility computing facility 230 includes a communicating agent 232 and management logic 234. The management logic 234 includes an farm state change notification agent 236 (FSCNA) and a database 238. The provisionable resources 250, 260, 270, 280 can each include respectively an installed reporting agent 252, 262, 272, 282 and an installed policy 254, 264, 274, 284.

A part of a monitoring utility, such as HP's OpenView Operations™ or IBM Tivoli™, can be associated with the NOC 210 to automatically monitor the provisionable resources 240. In this case, the automatic configuration interface 214 and the monitoring agent 216 can be implemented as a part of the monitoring utility for the purpose of automatically monitoring the provisionable resources 240.

According to one embodiment of the present invention, information describing the locations of provisionable resources 240 is automatically provided to the NOC 210. For example, information describing the location of a provisionable resource 250, 260, 270, 280, among other things, can be communicated from the provisionable resource 250, 260, 270, 280 to the NOC 210 through the utility computing facility 230, as will become more evident.

According to another embodiment, the information describing the location is used to automatically provide connectivity between the NOC 210 and the provisionable resource 250, 260, 270, 280. For example, a setup utility 220 can use the location to install software, such as a reporting agent 252, 262, 272, 282 and/or a policy 254, 264, 274, 284, on the provisionable resource 250, 260, 270, 280 to provide connectivity between the NOC 210 and the provisionable resource 250, 260, 270, 280, as will become more evident.

According to another embodiment, the NOC 210 is automatically configured to monitor provisionable resources 240. For example, as already described, the NOC 210 can automatically receive information describing the location of a provisionable resource 250, 260, 270, 280. The NOC 210 can use this information to automatically update the list of monitored resources 212 and to cause a reporting agent 224 and/or a policy 222 to be automatically installed on the provisionable resources 240, as will become more evident, resulting in installed reporting agents 252, 262, 272, 282 and installed policies 254, 264, 274, 284.

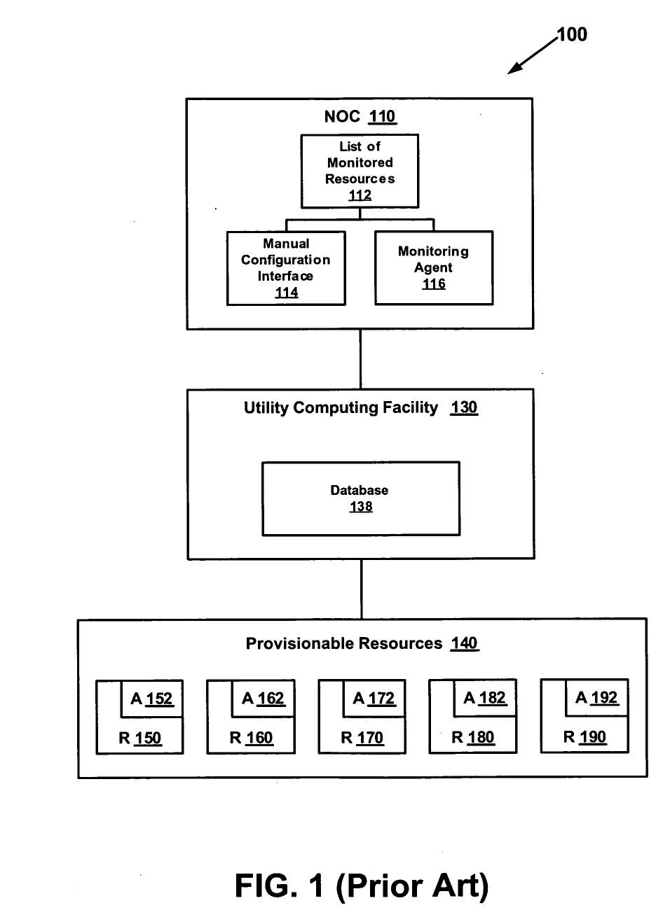

As already stated, the prior art system 100 (FIG. 1) requires manual configuration of the list of monitored resources 112. Without this manual configuration of the list of monitored resources 112, the NOC 110 may not receive any information pertaining to the provisionable resources 140.

According to yet another embodiment, the NOC 210 monitors the provisionable resources 240 directly. For example, the NOC 210 can use the installed reporting agents 252, 262, 272, 282 and/or policies 254, 264, 274, 284 to monitor the provisionable resources 240 directly. More specifically, the installed reporting agents 252, 262, 272, 282 and/or policies 254, 264, 274, 284 can be used to report information about the provisionable resource 250, 260, 270, 280 directly to the NOC 210 without the information passing through a utility computing facility 230.

According to another embodiment, the reporting agents 224 and the policies 222 that are initially installed can be “defaults” that have been implemented to work with a particular type of provisionable resource 250, 260, 270, 280. For example, since a lot is known about the various types of provisionable resources 240, default reporting agents 224 and default policies 222 can be created for the various types of provisionable resources 240. A default reporting agent 224 and/or default policy 222 that works for a particular type of provisionable resource 250, 260, 270, 280 can be installed on that provisionable resource 250, 260, 270, 280, as will become more evident.

According to still another embodiment, the NOC 210 automatically monitors the degree to how well a provisionable resource 250, 260, 270, 280 is performing (e.g., “health” of the provisionable resource 250, 260, 270, 280). For example, according to embodiments of the invention, a provisionable resource 250, 260, 270, 280 can be monitored not only for “up” and/or “down” status, but a provisionable resource 250, 260, 270, 280 can be monitored for the degree to how well the provisionable resource 250, 260, 270, 280 is performing. A reporting agent 252, 262, 272, 282 and/or policy 254, 264, 274, 284 can be used, at least in part, for reporting the degree to how well the provisiionable resource 250, 260, 270, 280 is performing, as will become more evident.

### PROVISIONABLE RESOURCES

A provisionable resource 250, 260, 270, 280 can be, for example, a server, a Quality of Service (QOS), a switch, or a firewall, among other things. In the case of a provisionable resource that is a server, any type of appropriate operating system, such as Windows™, HP-UX™, Linux™, etc., can be installed on the provisionable resource 250, 260, 270, 280. A QOS refers to determining how to treat received data (typically packets) based upon some criteria. For example, packets received from a department manager can be treated with a higher priority than packets received from an employee who works for the department manager. In a system 200 that provides provisionable resources 240, some servers can be dedicated to performing QOS and, therefore, are referred to as QOS servers.

Provisionable resources 240 can be grouped and managed as “farms.” For example, provisionable resources 250, 260 can, for example, be grouped into one farm while provisionable resources 270, 280 can be grouped into another farm.

### THE UTILITY COMPUTING FACILITY

The utility computing facility 230 can be used to manage provisionable resources 240. For example, a utility computing facility 230 can be used to group provisionable resources 240 into “farms.” More specifically, the utility computing facility 230 can be used to group provisionable resources 250, 260 can, for example, into one farm and group provisionable resources 270, 280 into another farm.

Information describing the “farms” can be stored in the database 238 associated with the utility computing facility 230. The utility computing facility 230 can use “farms,” for example, to allocate and de-allocate provisionable resources 240 to an application that needs resources, such as storage, to execute.

More specifically, if a provisionable resource 250, 260, 270, 280 associated with the allocated farm fails during the execution of the application, the utility computing facility 230 can replace the failed provisionable resource 250, 260, 270, 280 with another provisionable resource 250, 260, 270, 280 in a manner that is transparent to the execution. In so doing, the utility computing facility 230 may receive status indicating that the provisionable resource 250, 260, 270, 280 has failed and communicate that status to the NOC 210.

The utility computing facility 230 can select another provisionable resource 250, 260, 270, 280, allocate that selected provisionable resource 250, 260, 270, 280 to the farm and communicate this fact to the NOC 210 which can update its list of monitoring resources accordingly. The database 238 associated with the utility computing facility 230 can be updated to reflect that one provisionable resource 250, 260, 270, 280 has been removed from a farm and another provisionable resource 250, 260, 270, 280 has been added to that farm. A farm can be a VLAN.

The utility computing facility 230 can be Hewlett Packard's utility data center™, according to one embodiment.

### INFORMATION DESCRIBING THE PROVISIONABLE RESOURCES

As already stated herein, the automatic configuration interface 214 can be automatically configured with information describing the provisionable resources 240, for example, when the state of the provisionable resources 240 changes. More specifically, the information can include, among other things, an indicator as to what farm the provisionable resource 250, 260, 270, 280 belongs to, the state (e.g., “up” or “down”) of the provisionable resource 250, 260, 270, 280, a hostname of the provisionable resource 250, 260, 270, 280, and/or the location of the provisionable resource 250, 260, 270, 280, such as a network address, a network route, or an internet protocol address. Further, the information can include information describing the network infrastructure devices. For example, the information can be used to configure routing between internet protocol networks, the NOC 210, and provisionable resources 240 or to add the NOC 210 to the same virtual network that one or more of the provisionable resources are associated with.

The information describing a provisionable resource 250, 260, 270, 280 can be communicated to the NOC 210 when the utility computing facility 230 detects, for example, that a provisionable resource 250, 260, 270, 280 is activated, deactivated, updated, placed on standby, a replace-physical-device has been performed, or farm management is starting up. According to one embodiment, the utility computing facility 230 uses an FSCNA 236 to detect that a provisionable resource 250, 260, 270, 280 has been activated, deactivated, etc..

According to one embodiment, the information describing the provisionable resource 250, 260, 270, 280 can be associated, for example by piggybacking the information, on another communication mechanism, such as a notification. For example, a utility computing facility 230 may already use notifications to communicate changes in the state of provisionable resources 240. The location of provisionable resource 250, 260, 270, 280 can be associated with the notifications. The NOC 210 can receive the notifications and use the location information piggy backed on the notifications to install policies 222 and/or reporting agents 224 on the provisionable resources 240 for the purpose of automatically monitoring the provisionable resources 240.

### HEALTH OF A PROVISIONABLE RESOURCE

The NOC 210 can automatically monitor the degree of how well a provisionable resource 250, 260, 270, 280 is performing (also known as the “health” of a provisionable resource 250, 260, 270, 280). For example, provisionable resources 240 usually fail in degrees. According to embodiments of the invention, a provisionable resource 250, 260, 270, 280 can be monitored not only for the “up” and/or “down” status, but a provisionable resource 250, 260, 270, 280 can be monitored for the degree to how well the provisionable resource 250, 260, 270, 280 is performing.

For example, any kind of information that describes the degree to how well a provisionable resource 250, 260, 270, 280 is performing can be monitored, such as the percent of CPU utilization, the percent of disk utilization, the amount of disk fragmentation, the throughput over a communications channel, the throughput of an application programming interface (API), etc.. Further, the information describing how well a provisionable resource 250, 260, 270, 280 is performing can be used to automatically load balance the system 200 (FIG. 2), for example, by moving activities from a provisionable resource 250, 260, 270, 280 that is under performing (e.g., has “poor health”) to another provisionable resource 250, 260, 270, 280 that is performing well (e.g., has “good health”).

### POLICIES AND REPORTING AGENTS

The setup utility 220 can install policies 222 and/or reporting agents 224 on provisionable resources 240 (resulting in installed policies 254, 264, 274, 284 and installed reporting agents 252, 262, 272, 282) to allow the NOC 210 to automatically and directly monitor the “health” of provisionable resources 240.

Policies 222, 254, 264, 274, 284 can include rules for indicating what types of conditions the reporting agents 252, 262, 272, 282 are to report back to the NOC 210. For example, a policy 222, 254, 264, 274, 284 can include a rule that the CPU utilization is to be reported. A reporting agent 252, 262, 272, 282 that is installed on the same provisionable resource 250, 260, 270, 280 as that policy 254, 264, 274, 284 can use that rule (e.g., report CPU utilization) to determine that it should report CPU utilization.

According to one embodiment, the uninstalled policies 222 and/or reporting agents 224 are “defaults.” For example, since a lot is known about each type of provisionable resource 250, 260, 270, 280 and each type of operating system 200 running on provisionable resources 240 that are servers, for example, default reporting agents 224 and default policies 222 can be written for the purpose of reporting the “health” of any type of provisionable resource 250, 260, 270, 280. For example, one default policy 222 can include rules for servers running Windows™, another default policy 222 can have rules for servers running HP-UX, a third default policy 222 can have rules for switches, a fourth default policy 222 can have rules for fire walls, etc.. The default reporting agent 224 and/or default policy 222 that works for a particular type of provisionable resource 250, 260, 270, 280 can be selected and installed on that provisionable resource 250, 260, 270, 280, as will become more evident.

Customers that own and/or use the provisionable resources 240 can customize a policy 254, 264, 274, 284 for the applications they installed on a provisionable resource 250, 260, 270, 280. For example, the customer can customize a policy 254, 264, 274, 284 to indicate that they want the throughput of an API, which is associated with the same provisionable resource 250, 260, 270, 280 that the policy 254, 264, 274, 284 is installed on, to be monitored.

### AN OPERATIONAL EXAMPLE

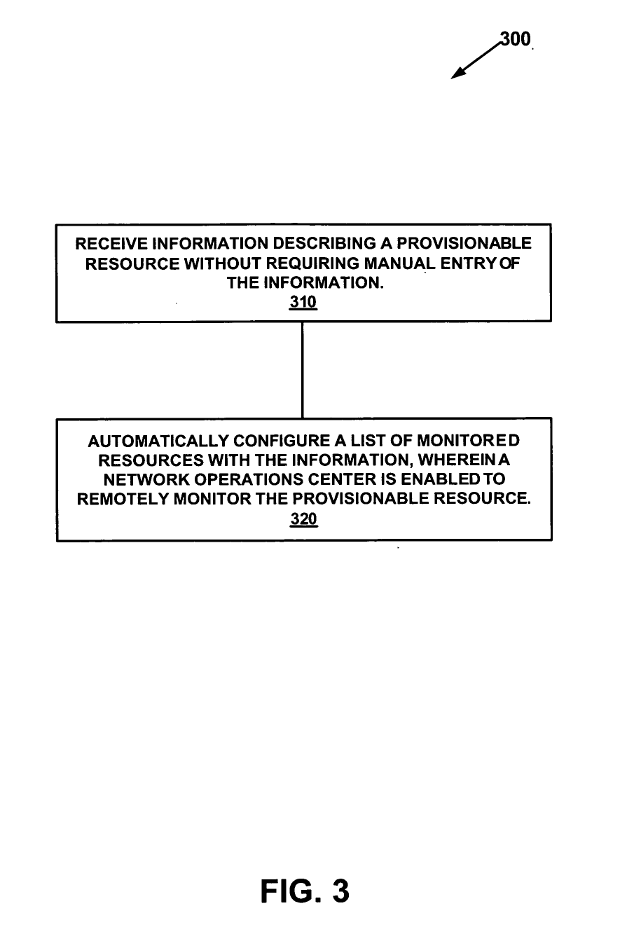

FIG. 3 depicts a flowchart 300 for automatically configuring remote monitoring of provisionable resources 240, according to embodiments of the present invention. Although specific steps are disclosed in flowchart 300, such steps are exemplary. That is, embodiments of the present invention are well suited to performing various other steps or variations of the steps recited in flowchart 300. It is appreciated that the steps in flowchart 300 may be performed in an order different than presented, and that not all of the steps in flowchart 300 may be performed. All of, or a portion of, the embodiments described by flowchart 300 can be implemented using computer-readable and computer-executable instructions which reside, for example, in computer-usable media of a computer system 200 or like device.

As described above, certain processes and steps of the present invention are realized, in one embodiment, as a series of instructions (e.g., software program) that reside within computer readable memory of a computer 5 system 200 and are executed by the of the system 200. When executed, the instructions cause the computer system 200 to implement the functionality of the present invention as described below.

For the purposes of illustrating the following operational example, the discussion of flowchart 300 shall refer to the structures depicted in FIG. 2. Further, for the purposes of illustration, assume that the system 200 is configured with default policies 222 and default reporting agents 224. For example, assume that the setup utility 220 in the NOC 210 has already been configured with default policies 222 and default reporting agents 224, and that a provisionable resource 250 is added to a farm.

In step 310, information describing a provisionable resource is received without requiring manual entry of the information, according to one embodiment. For example, when a provisionable resource 250 is first associated with the system 200, the FSCNA 236 can receive a status message (e.g., notification) indicating that the provisionable resource 250 has been added to a farm. The status message (e.g., received information) can include, for example, the location (such as a network address) of the provisionable resource 250. The FSCNA 236 can compare the received information with what is in the database 238 to determine if anything has changed. The FSCNA can update the database 238 based on the received information. The management logic 234 can communicate the received information to the communicating agent 232. The communicating agent 232 can communicate the received information to the automatic configuration interface 214.

In step 320, a list of monitored resources is automatically configured with the information, wherein a network operations center is enabled to remotely monitor the provisionable resource, according to another embodiment. For example, the automatic configuration interface 214 can update the list of monitored resources 212 based on received information.

The setup utility 220 can use the information (such as the location of the provisionable resource 250) to locate the provisionable resource 250 and determine what type of resource the provisionable resource 250 is. The setup utility 220 can select an appropriate default reporting agent 224 and default policy 222 for the provisionable resource 250. The setup utility 220 can use the information (such as the location of the provisionable resource 250) to cause the default reporting agent 224 and/or the default policy 222 to be installed on the provisionable resource 250.

The installed reporting agent 252 can report the “health” of the provisionable resource 250 based on the installed policy 254 to the monitoring agent 216, thus, the NOC 210 is enabled to remotely monitor the provisionable resource 250. Further, the NOC 210 is enabled to monitor the provisionable resource 250 directly without involving the utility computing facility 230. For example, the reporting agent 252 can communicate information describing the “health” directly to the provisionable resource 250 without the information describing the “health” going from the provisionable resource 250 to the utility computing facility 230 and finally to the NOC 210.

### EXTENSIONS AND ALTERNATIVES

Although certain embodiments of the present invention were described with the setup utility 220 residing in the NOC 210, the setup utility 220 could be a part of the monitoring agent 216 or the utility computing facility 230 instead.

Although certain embodiments of the present invention were described with the uninstalled policies 222 and reporting agents 224 residing in the setup utility 220, the uninstalled policies 222 and reporting agents 224 could reside on the utility computing facility 230 instead. In this case, the communicating agent 232 could communicate them (222, 224) to the NOC 210 which in turn causes them (222, 224) to be installed on the provisionable resources 240.

The monitoring agent 216 could be a part of or communicate with a prior art monitoring service 116.

Embodiments of the present invention are thus described. While the present invention has been described in particular embodiments, it should be appreciated that the present invention should not be construed as limited by such embodiments, but rather construed according to the following claims.

What is claimed is:

1. A method of automatically configuring remote monitoring of a provisionable resource, the method comprising:
receiving information describing the provisionable resource without requiring manual entry of the information; and
automatically configuring a list of monitored resources with the information, wherein a network operations center is enabled to remotely monitor the provisionable resource.

2. The method as recited in claim 1:
wherein the receiving the information describing the provisionable resource further comprises receiving information describing a location of the provisionable resource; and
wherein the automatically configuring the list of monitored resources further comprises storing the information describing the location in the list of monitored resources, wherein the location, at least in part, enables the network operations center to remotely monitor the provisionable resource.

3. The method as recited in claim 1, the method further comprising:
automatically installing a policy and a reporting agent on the provisionable resource, wherein the reporting agent uses the policy to determine what information about the provisionable resource to report to the network operations center.

4. The method as recited in claim 3, wherein the method further comprises:
automatically selecting the policy and the reporting agent based on what type of resource the provisionable resource is.

5. The method as recited in claim 3, wherein the automatically installing the policy and the reporting agent further comprises:
installing a default policy and a default reporting agent on the provisionable resource.

6. The method as recited in claim 1, the method further comprises:
receiving, at the network operations center, information describing a degree of wellness associated with the provisionable resource; and
using the information describing the degree of wellness to monitor the provisionable resource.

7. The method as recited in claim 6, wherein the receiving, at the network operations center, the information describing the degree of wellness further comprises:
receiving the information describing the degree of wellness that is selected from a group consisting of a percent of CPU utilization, a percent of disk utilization, an amount of disk fragmentation, a throughput over a communications channel, and a throughput of an application programming interface (API).

8. An apparatus for automatically configuring remote monitoring of a provisionable resource, the method comprising:
an automatic configuration interface;
a list of monitored resources coupled to the automatic configuration interface;
the automatic configuration interface receives information describing the provisionable resource without requiring manual entry of the information; and
the automatic configuration interface automatically configures the list of monitored resources with the information, wherein a network operations center is enabled to remotely monitor the provisionable resource.

9. The apparatus of claim 8, wherein a utility computing facility provides the information describing the provisionable resource to the automatic configuration interface.

10. The apparatus of claim 9, wherein the utility computing facility is Hewlet Packard's Utility Data Center™.

11. The apparatus of claim 8, wherein the automatic configuration interface and the list of monitored resources reside on the network operations center.

12. The apparatus of claim 8, wherein policies and reporting agents reside on software selected from a group consisting of the network operations center and a utility computing facility

13. The apparatus of claim 8:
wherein the information describing the provisionable resource includes information describing a location of the provisionable resource; and
wherein the information describing the location enables the network operations center, at least in part, to remotely monitor the provisionable resource.

14. The apparatus of claim 8, the apparatus further comprises:
a setup utility for automatically installing a policy and a reporting agent on the provisionable resource, wherein the reporting agent uses the policy to determine what information about the provisionable resource to report to the network operations center.

15. The apparatus of claim 14, wherein the setup utility selects the policy and the reporting agent based on what type of resource the provisionable resource is.

16. The apparatus of claim 15, wherein the information describing the degree of wellness that is selected from a group consisting of a percent of CPU utilization, a percent of disk utilization, an amount of disk fragmentation, a throughput over a communications channel, and a throughput of an application programming interface (API).

17. The apparatus of claim 14, wherein the policy is a default policy and the reporting agent is a default reporting agent.

18. The apparatus of claim 8, wherein:
the network operations center receives information describing a degree of wellness associated with the provisionable resource; and
the network operations center uses the information describing the degree of wellness to monitor the provisionable resource.

19. A computer-usable medium having computer-readable program code embodied therein for causing a computer system to perform a method of automatically configuring remote monitoring of a provisionable resource, the method comprising:
receiving information describing the provisionable resource without requiring manual entry of the information; and
automatically configuring a list of monitored resources with the information, wherein a network operations center is enabled to remotely monitor the provisionable resource.

20. The computer-usable medium of claim 19, wherein the computer-readable program code embodied therein causes a computer system to perform the method, and wherein the method further comprises:
automatically installing a policy and a reporting agent on the provisionable resource, wherein the reporting agent uses the policy to determine what information about the provisionable resource to report to the network operations center.
